(19) United States
(12) Patent Application Publication
(10) Pub. No.: US 2020/0254402 A1
(43) Pub. Date: Aug. 13, 2020

(54) CONSTRUCTION MATERIAL MIXER

(71) Applicant: Ammann Schweiz AG, Langenthal (CH)

(72) Inventor: Ingolf Detloff, Rechberghausen (DE)

(21) Appl. No.: 16/760,500

(22) PCT Filed: Nov. 2, 2017
(86) PCT No.: PCT/EP2017/078089

§ 371 Date: Apr. 30, 2020

(51) Int. Cl. B01F 7/00

(52) U.S. Cl. CPC B01F 7/001; B28C 5/12; B01F 7/00158

(57) ABSTRACT

The invention relates to a construction material mixer, in particular an asphalt or concrete mixer, consisting of a container (1) having at least one driven shaft (5) to which mixing arms (6) carrying blades (12) are fastened at intervals, the blades (12) being at a distance from the inner wall of the container (1), the mixing arms (6) being divided into an inner part (11), which is connected to the shaft (5), and an outer part (13), which carries the blades (12), and both parts being connectable to each other by means of an adjustable connection device (22). The invention is based on the fact that the connection device (22) is a snap connection device. A particular embodiment and a rapid blade replacement method are described.

### CROSS-REFERENCE TO RELATED APPLICATIONS

This application is a National Stage application of International Patent Application No. PCT/EP2017/078089, filed on Nov. 2, 2017, which is hereby incorporated by reference in its entirety.

### TECHNICAL FIELD

The invention relates to a construction material mixer, in particular an asphalt or concrete mixer, according to the preamble of claim 1.

### BACKGROUND

Construction material mixers generally consist of a container having at least one driven shaft to which perpendicular to the shaft mixing arms carrying blades are fastened at intervals. The blades are arranged at a distance from the inner wall of the container. The mixing arms comprise an inner part, which is connected to the shaft, and an outer part, which carries the blades. These two parts are connectable with each other by means of an adjustable connection device comprising screws. The ultimate operational connection between the outer parts and the inner parts is established by means of a multitude of screw connections, and in fact on-site, when the worn out blades need to be replaced.

In the known construction material mixers, as e.g. described in the subsequent publications (WO2006/007778A1, EP0111148A2, EP2007275700, U.S. Pat. Nos. 3,738,774, 5,061,082, DE9410951U1, U.S. Pat. Nos. 3,773,436, 3,773,436A, CH408743A), the exchange of the worn out blades is associated with an enormous expenditure of time, since all screw connections of the mixing arms—a construction material mixer normally comprises a multitude of mixing arms—need to be actuated at least once. In case the parts are moreover worn out, agglutinated by adhering mixing material or welded together, additional measures need to be taken (for example cutting torch or cutting grinder), in order to equip the construction material mixer with new blades.

### SUMMARY

Taking the above prior art as starting point, the objective underlying the invention is to find a remedy to this problem and to further develop the know mixer without undue constructional burden in such a way that the replacement of the blades is possible at a minimum expenditure of time.

This objective is accomplished by the features of claim 1.

It is visible that the invention is realized in case the operational connection between the inner part and the outer part of a mixing arm in a construction material mixer is accomplished by means of a plug-in, latching, snap-action and/or a bayonet joint connection. By way of this it is possible to mount new blades without the use of tools.

Further practical and advantageous arrangements of the invention emerge from the dependent claims.

According to a further embodiment of the invention, the snap-action connection device consists on the one hand of two trunnions having snap-in openings, which are arranged parallel to the mixing arm at the front end of the inner part and at a distance to each other corresponding to the diameter of a bolt carrying the blade. On the other hand, the snap-in connection device comprises two centrally perforated formed components, which enclose the trunnions, one of which is provided with two spring shackles which can be fitted into snap-in openings in the trunnions, as well as a bolt carrying the blade, which makes possible an operational connection between the formed components. By means of this connection the individual components are connected via the bolts with the blade, for thereafter establishing an operational connection of the outer part with the inner part, which comprises the trunnions. The assembling of the outer part is done in the factory, while the equipping of the construction material mixer with new blades is done on-site.

According to a further embodiment of the invention, the individual component which is not equipped with the spring shackles is designed as a cage receiving the snap-in catches. By means of this, a tilting of the blade can be counteracted.

By embodying the construction material mixer according to the invention, the distances of the blades to the inner wall of the container can be adjusted in a simple manner, in that at the adjoining location between the outer part and the inner part distancing elements of different thicknesses are arranged.

The invention further relates to a method for conducting the replacement of blades at construction material mixers. For doing so, the protective cover is removed from the bushing, the connection is released and the blade to be replaced is removed. Thereafter, the pre-manufactured snap-action connection device with the new blade is plugged on the trunnions. In this way the snap-in connection devices can be released particularly quick and the old blade can be removed.

### BRIEF DESCRIPTION OF THE DRAWINGS

The invention will now further be explained by way of examples. It show:

FIG. 1 a section through a construction material mixer with one mixing arm depicted and further mixing arms indicated,

FIG. 2 a perspective view of a mixing arm (inner part) and a lateral exploded view of an outer part (blade and snap-in device),

FIG. 3 a perspective view of FIG. 2 laterally from the front, and

FIG. 4 a perspective view of FIG. 2 laterally from the back.

### DETAILED DESCRIPTION

The figures show a construction material mixer comprising a cylindrical container 1 having a driven central shaft 5 to which, perpendicularly to the shaft, mixing arms 6 carrying blades 12 are fastened at intervals. Generally it is possible that the axles of the mixing arms together with the axle of the shaft 5 form a different angle. The blades 12 are at a distance to the inner wall of the container 1. The mixing arms 6 are divided into an inner part 11, which is connected to the shaft 5, and an outer part 13, which carries the blade 12. Both parts are connectable with each other by means of an adjustable connection device 14. The connection device is generally embodied in such a manner that the ultimate operational connection between the two parts, thus between the inner part and the outer part, is established by plugging, latching and/or twisting. The advantage of these connections consists in that they can be established without tools, which is of particularly importance when a multitude of blades are exchanged.

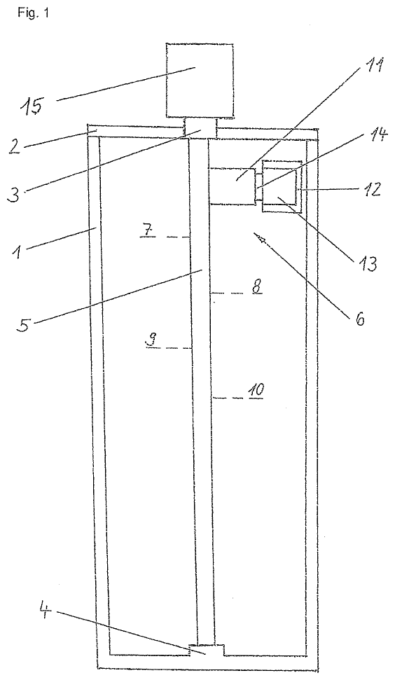

In FIG. 1 a construction material mixer is shown. It consists of a cylindrical container 1, which is closed with a cover 2. Centrally inside the container 1 a shaft 5 is mounted by means of bearings 3, 4, to which mixing arms are fastened. Only one mixing arm 6 is depicted into detail, others 7-10 are merely indicated. The shaft 5 normally carries a multitude of mixing arms with blades, which preferably rectangularly stick out from the shaft 5. The shaft is put into rotation by means of a drive 15, for example an electric motor.

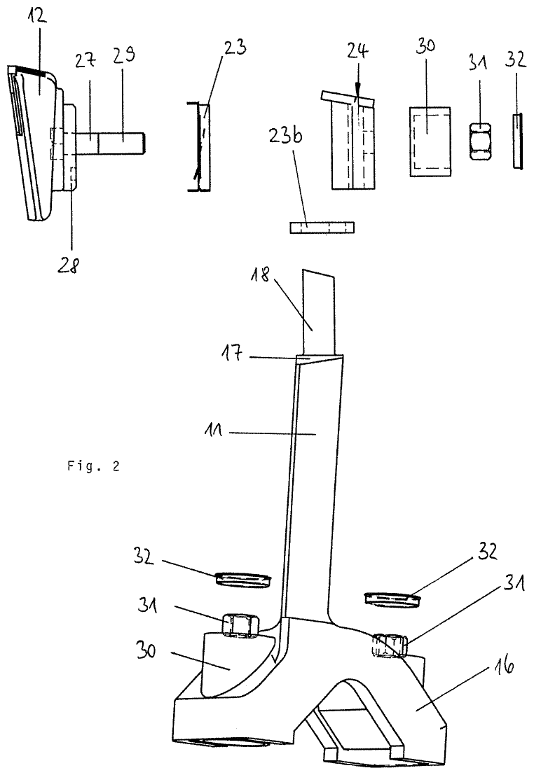

The mixing arm 6 comprises an inner part 11, which is connected to the shaft 5, and an outer part 13, which carries the blade 12, wherein both parts are connectable with each other in a releasable manner by means of an adjustable connection device 14. The mixing arm 6 is depicted in the FIGS. 2-4 more into detail.

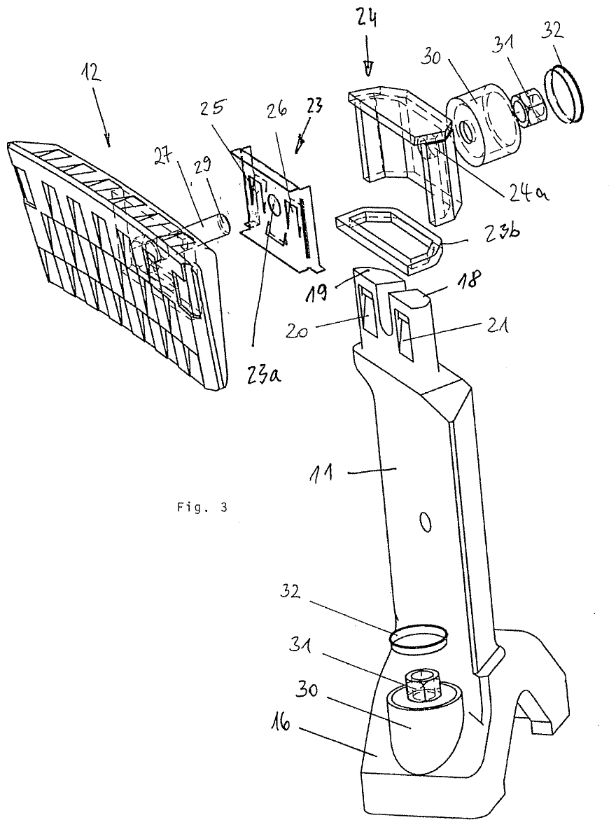

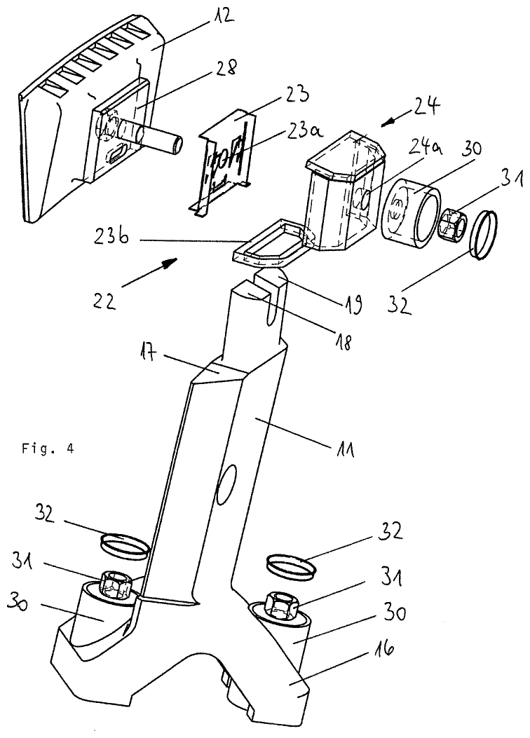

The inner part 11 consists according to FIG. 2 of a mixing arm base 16, which is for example by means of a screw connection fastened to the shaft, and of a formed component protruding from the base, from the base free front face 17 of which two trunnions 18, 19 (FIGS. 3 and 4) protrude parallel to the formed component. These trunnions comprise snap-in recesses or snap-in openings 20, 21, and thereby form part of a snap-action device 22 (FIG. 4). A second part of the snap-action device 22 is formed by two centrally perforated formed components 23, 24. The formed part 23 is provided with two spring shackles 25, 26 which are arranged laterally to the perforation 23a, which can be introduced into the snap-in openings 20, 21. The formed component 24 is complemented to form a cage, which serves for receiving the two trunnions 18 and 19 and for protecting them from working material. The perforations 23a and 24a of the formed components 23, 24 are penetrated by a bolt 27, at the one end of which there is fastened a blade 12 over a square piece 28, and which at its other end is provided with a threaded section 29. This threaded section 29 in the operational state of the outer part 13 (FIG. 1) is provided with a nut 31, which for its part can be covered by a bushing 30 with a protection cover 32. The bushing 30 can be closed with the protection cover 32 arranged at its end in order to protect the screw connection against working material. It is substantially a can-cover connection, which is releasable in simple manner. The square piece 28 serves in connection with chamfers of the formed component 23 for preventing a turning of the blade 12.

The unit consisting of the parts 12, 28, 27, 29, 23, 24, 30, 31, 32 is pre-assembled in case of a replacement of the blade, wherein the nut 31 of the screw connection is tightened. This screw connection merely serves for holding together the above designated unit, but not for establishing a screw connection between the outer part 13 and the blade 12, respectively, and the inner part (arm) 11, as is the case in the conventional construction material mixers, in which the actual connection between the arm and the blade is established by means of a screw connection, which upon replacement of the blade must be released, namely with a specific tool.

The structure of the mixing arm thus is made in such a manner that, instead of using a conventional cutting torch or cutting grinder, one can in very short time remove the protection cover 32, release the nut 31, which holds together the unit, and remove the worn out blade from the snap-action connection device 22. The new unit can then equally quickly be mounted onto the trunnions 18, 19, wherein the snap-in spring shackles 25, 26 snap-in the snap-in openings 20, 21. In doing so, the distance of the blade edge to the inner wall of the container 1 can be adjusted by means of distance elements 23b, which are put over the trunnions 18, 19.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A construction material mixer, comprising a container having at least one driven shaft to which mixing arms carrying blades are fastened at intervals, wherein the mixing arms comprise an inner part, which is connected to the shaft, and an outer part, which carries the blades, which parts are connectable with each other,
wherein the inner part is connectable with the outer part by means of a plug-in, latching, snap-action and/or a bayonet joint connection.

2. The construction material mixer according to claim 1, wherein the mixing arms, which are detachably connectable with the shaft, are arranged perpendicularly to the shaft.

3. The construction material mixer according to claim 1, wherein a snap-action connection device having at least one trunnion provided with snap-in openings and spring shackles working together with snap-in openings in operational state.

4. The construction material mixer according to claim 3, wherein the trunnions are arranged at the front end of the inner part parallel to the mixing arm and at a distance of at least the diameter of bolts carrying the blade.

5. The construction material mixer according to claim 3, wherein formed components which are perforated and can be assembled to form a hollow body, one of which comprises spring shackle working together with snap-in openings of the trunnions and which are traversed by the bolt carrying the blade.

6. The construction material mixer according to claim 3, wherein the formed components in the operational state form a cage receiving the trunnions.

7. The construction material mixer according to claim 1, wherein the bolt carrying the blade runs perpendicular to the axle and is connected with the cage in a friction-locked manner.

8. The construction material mixer according to claim 4, wherein the free end of the bolt is provided with a clamping body, e.g. eccentric or nut, which is suitable to connect the parts of the cage in a friction-locked manner.

9. The construction material mixer according to claim 8, wherein the clamping body can be covered with a hollow body in a manner devoid of material.

10. The construction material mixer according to claim 9, wherein the hollow body is embodied in the manner of a can with cover.

11. The construction material mixer according to claim 1, wherein an inner part and an outer part which are connectable for operational work by means of plug-in or snap-in connections.

12. A method for conducting the replacement of blades at construction material mixers according to claim 1, wherein friction-locked connection between the clamping body and the bolt is released, thereafter the outer part with the worn out blade is removed and finally a new outer part with a blade is plugged on the inner part.

13. The construction material mixer according to claim 2, wherein a snap-action connection device having at least one trunnion provided with snap-in openings and spring shackles working together with snap-in openings in operational state.

14. The construction material mixer according to claim 4, wherein formed components which are perforated and can be assembled to form a hollow body, one of which comprises spring shackle working together with snap-in openings of the trunnions and which are traversed by the bolt carrying the blade.

15. The construction material mixer according to claim 4, wherein the formed components in the operational state form a cage receiving the trunnions.

16. The construction material mixer according to claim 5, wherein the formed components in the operational state form a cage receiving the trunnions.

17. The construction material mixer according to claim 2, wherein the bolt carrying the blade runs perpendicular to the axle and is connected with the cage in a friction-locked manner.

18. The construction material mixer according to claim 3, wherein the bolt carrying the blade runs perpendicular to the axle and is connected with the cage in a friction-locked manner.

19. The construction material mixer according to claim 4, wherein the bolt carrying the blade runs perpendicular to the axle and is connected with the cage in a friction-locked manner.

20. The construction material mixer according to claim 5, wherein the bolt carrying the blade runs perpendicular to the axle and is connected with the cage in a friction-locked manner.
